(19) United States
(12) Patent Application Publication
(10) Pub. No.: US 2025/0155967 A1
(43) Pub. Date: May 15, 2025

(54) INFORMATION PROCESSING METHOD, INFORMATION PROCESSING DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventors: Minami NAKA, Osaka (JP); Tadamasa TOMA, Osaka (JP); Satoshi MATSUI, Kyoto (JP)

(21) Appl. No.: 19/022,156

(22) Filed: Jan. 15, 2025

Related U.S. Application Data
(63) Continuation of application No. PCT/JP2023/026001, filed on Jul. 14, 2023.
(60) Provisional application No. 63/368,826, filed on Jul. 19, 2022.

(30) Foreign Application Priority Data
Jun. 13, 2023 (JP) 2023-097279

(51) Int. Cl. G06F 3/01

(52) U.S. Cl. CPC G06F 3/011

(57) ABSTRACT

An information processing device acquires positional information and posture information of a worker in a real space, the positional information and the posture information being used to update a position and posture of a virtual camera installed in a virtual space imitating a position and posture of the worker and the real space; determines whether the worker is in a stable state based on the positional information; and reduces an updating frequency of the positional information and the posture information when it is determined that the worker is not in the stable state, rather than when it is determined that the worker is in the stable state.

### FIELD OF INVENTION

The present disclosure relates to a technology to remotely support a worker at a worksite.

### BACKGROUND ART

Patent Literature 1 discloses a three-dimensional (3D) model generation device that generates a 3D model of a subject by the volume intersection method based on camera videos of a zoom-in camera and a zoom-out camera, in which the 3D model is generated assuming that the subject exists outside an angle of view range of the zoom-in camera.

However, Patent Literature 1 merely generates a virtual camera video closed in a virtual space, and does not disclose generating a virtual camera video associated with a real space. Therefore, in Patent Literature 1, the problem of the virtual camera video being generated with low visibility does not occur if the position and posture of a virtual camera are updated by using the position and posture of the worker during a period when the worker is moving significantly.

Patent Literature 1: JP 2022-29730 A

### SUMMARY OF THE INVENTION

The present disclosure has been made to solve such problems, and an object thereof is to provide a technology to prevent the virtual camera video with rapid changes and low visibility from being generated.

An information processing method according to one aspect of the present disclosure is an information processing method in an information processing device for supporting work of a worker, the information processing method including: acquiring positional information and posture information of the worker in a real space, the positional information and the posture information being used to update a position and posture of a virtual camera installed in a virtual space imitating the real space; determining whether the worker is in a stable state based on the positional information; and reducing an updating frequency of the positional information and the posture information when it is determined that the worker is not in the stable state, rather than when it is determined that the worker is in the stable state.

The present disclosure can prevent the virtual camera video with rapid changes and low visibility from being generated.

### BRIEF DESCRIPTION OF THE DRAWINGS

FIG. 1 is a block diagram showing one example of an entire configuration of an information processing system in a first embodiment.

FIG. 2 is a diagram showing an outline of the process of the information processing system.

FIG. 3 is a diagram showing a state of spatial calibration.

FIG. 4 is a diagram showing a state of spatial calibration.

FIG. 5 is a flowchart showing one example of the process of the information processing system in the first embodiment.

FIG. 6 is a flowchart showing one example of the process of an information processing system in a second embodiment.

FIG. 7 is a flowchart showing one example of the process of an information processing system in a third embodiment.

FIG. 8 is a flowchart showing one example of the process of an information processing system in a fourth embodiment.

FIG. 9 is a flowchart showing one example of the process of an information processing system in a fifth embodiment.

### DETAILED DESCRIPTION

### Knowledge Underlying Present Disclosure

When a worker performs a work on a target object at a worksite, the worker may proceed with the work while confirming an instruction from a remote person outside the worksite. In this case, if the remote person can confirm which part of the target object the worker is looking at, the remote person can smoothly instruct the worker. In order to achieve this situation, for example, when an imaging device such as an action camera or a smart glass is attached to the head of the worker and a video of the worksite captured by the imaging device is transmitted in real time to a remote terminal of the remote person, the remote person can confirm which part of the target object the worker is looking at.

However, at some worksites, it is prohibited to output a video to the outside from the viewpoint of security. In this case, there is a problem that the remote person cannot confirm the part the worker is looking at.

Therefore, the present inventors are considering a technology to generate a virtual camera video that reproduces the worker's field of view at the worksite on the virtual space by synchronizing the position and posture of the worker at the worksite with the position and posture of the virtual camera, and display the generated virtual camera video on a remote terminal of the remote person.

In this technology, when the position and posture of the worker are constantly synchronized with the position and posture of the virtual camera, the synchronization is performed even during periods of significant movement of the worker such as the period during walking or the period when walking starts and ends. During such periods of significant movement, frequent changes in the position and posture of the worker result in the generation of the virtual camera video that shakes and changes rapidly. Such a rapidly changing virtual camera video may be difficult to visually recognize, and the remote person visually recognizing the virtual camera video may also experience motion sickness. It is sufficient for the remote person to be able to check the actions of the worker who is performing some kind of work on the target object; there is no need for the remote person to check detailed actions such as camera shake. In addition, since the worker remains at the place during the work, the position and posture do not change drastically.

Therefore, the inventors have found that the generation of the virtual camera video with rapid changes and low visibility can be prevented if an updating frequency of the position and posture of the virtual camera by using the positional information and the posture information is reduced when the worker is not in the stable state, rather than when the worker is in the stable state, and then the present inventors have come up with the present disclosure.
(1) An information processing method according to one aspect of the present disclosure is an information processing method in an information processing device for supporting work of a worker, the information processing method including: acquiring positional information and posture information of the worker in a real space, the positional information and the posture information being used to update a position and posture of a virtual camera installed in a virtual space imitating the real space; determining whether the worker is in a stable state based on the positional information; and reducing an updating frequency of the positional information and the posture information when it is determined that the worker is not in the stable state, rather than when it is determined that the worker is in the stable state.

With this configuration, the updating frequency of the position and posture of the virtual camera by using the positional information and the posture information is reduced when the worker is not in the stable state, rather than when the worker is in the stable state. Therefore, the position and posture of the virtual camera become stable, preventing the virtual camera video with rapid changes and low visibility from being generated.
(2) In the information processing method according to (1), the stable state may indicate a state where the worker is not accelerating or decelerating.

With this configuration, when the worker is accelerating and decelerating, the updating frequency of the position and posture of the virtual camera by using the positional information and the posture information is reduced, preventing the virtual camera video with rapid changes and low visibility from being generated.
(3) In the information processing method according to (2), the determination may include: calculating an acceleration level from the positional information: determining that the worker is not in the stable state when an absolute value of the acceleration level exceeds a reference acceleration level; and determining that the worker is in the stable state when the absolute value of the acceleration level is less than the reference acceleration level.

With this configuration, when the absolute value of the acceleration level calculated from the positional information exceeds the reference acceleration level, it is determined that the worker is in an accelerating state and decelerating state, allowing accurate detection that the worker is in the accelerating state and decelerating state.
(4) In the information processing method according to (1), the stable state may indicate a state where the worker is stopped.

With this configuration, when the worker is moving, the updating frequency of the position and posture of the virtual camera by using the positional information and the posture information is reduced, preventing the virtual camera video with rapid changes and low visibility from being generated.
(5) In the information processing method according to (4), the determination may include: calculating a speed from the positional information; determining that the worker is not in the stable state when the speed exceeds a reference speed; and determining that the worker is in the stable state when the speed is less than the reference speed.

With this configuration, when the speed calculated from the positional information exceeds the reference speed, it is determined that the worker has moved, allowing accurate detection whether the worker has moved or not.
(6) In the information processing method according to any one of (1) to (5), the determination may include determining whether a period from a last update of the positional information and the posture information until present time exceeds a certain period when it is determined that the worker is not in the stable state, and the reducing the updating frequency may include performing the update when it is determined that the period exceeds the certain period.

This configuration makes it possible to prevent the position and posture of the virtual camera from being not updated by using the position and posture of the worker for a long period of time.
(7) The information processing method according to any one of (1) to (6) may further include performing a correction process to correct the positional information and the posture information by applying a low-pass filter to displacement of the positional information and displacement of the posture information, in which the correction process may include making a cutoff frequency of the low-pass filter lower when it is determined that the worker is not in the stable state, rather than when it is determined that the worker is in the stable state.

With this configuration, when the worker is not in the stable state, the cutoff frequency of the low-pass filter is shifted to the lower frequency side, rather than when the worker is in the stable state. Therefore, the positional information and the posture information are acquired with rapid changes removed. Therefore, the positional information and the posture information become stable, preventing the virtual camera video with rapid changes and low visibility from being generated.
(8) The information processing method according to any one of (1) to (7) may further include: updating the position and posture of the virtual camera by using the positional information and the posture information; generating a virtual camera video by capturing the virtual space with the virtual camera; and displaying the virtual camera video on a display.

With this configuration, the virtual camera video that reproduces the worker's field of view in the real space on the virtual space can be displayed.
(9) In the information processing method according to any one of (1) to (8), the reducing the updating frequency may include: not performing the update when it is determined that the worker is not in the stable state; and performing the update when it is determined that the worker is in the stable state.

With this configuration, the positional information and the posture information are updated only when the worker is in the stable state, preventing the virtual camera video with rapid changes and low visibility from being generated more reliably.
(10) An information processing device according to another aspect of the present disclosure is an information processing system that includes a processor and supports work of a worker, in which the processor performs processing of: acquiring positional information and posture information of the worker in a real space, the positional information and the posture information being used to update a position and posture of a virtual camera installed in a virtual space imitating the real space; determining whether the worker is in a stable state based on the positional information; and reducing an updating frequency of the positional information and the posture information when it is determined that the worker is not in the stable state, rather than when it is determined that the worker is in the stable state.

With this configuration, the information processing device that prevents the virtual camera video with rapid changes and low visibility from being generated can be provided.
(11) An information processing program according to still another aspect of the present disclosure is an information processing program for causing a computer to execute an information processing method for supporting work of a worker, the information processing program causing the computer to perform processing of: acquiring positional information and posture information of the worker in a real space, the positional information and the posture information being used to update a position and posture of a virtual camera installed in a virtual space imitating the real space; determining whether the worker is in a stable state based on the positional information; and reducing an updating frequency of the positional information and the posture information when it is determined that the worker is not in the stable state, rather than when it is determined that the worker is in the stable state.

With this configuration, the information processing program that prevents the virtual camera video with rapid changes and low visibility from being generated can be provided.

The present disclosure can be also implemented as an information update system that is operated by such an information processing program. It is needless to say that such a computer program can be distributed via a computer-readable non-transitory recording medium such as a CD-ROM or via a communication network such as the Internet.

Note that each of embodiments to be described below illustrates a specific example of the present disclosure. Numerical values, shapes, components, steps, order of steps, and the like shown in the embodiments below are one example, and are not intended to limit the present disclosure. Furthermore, a component that is not described in an independent claim representing the highest concept among components in the embodiments below will be described as an arbitrary component. In all the embodiments, respective contents can be combined.

### First Embodiment

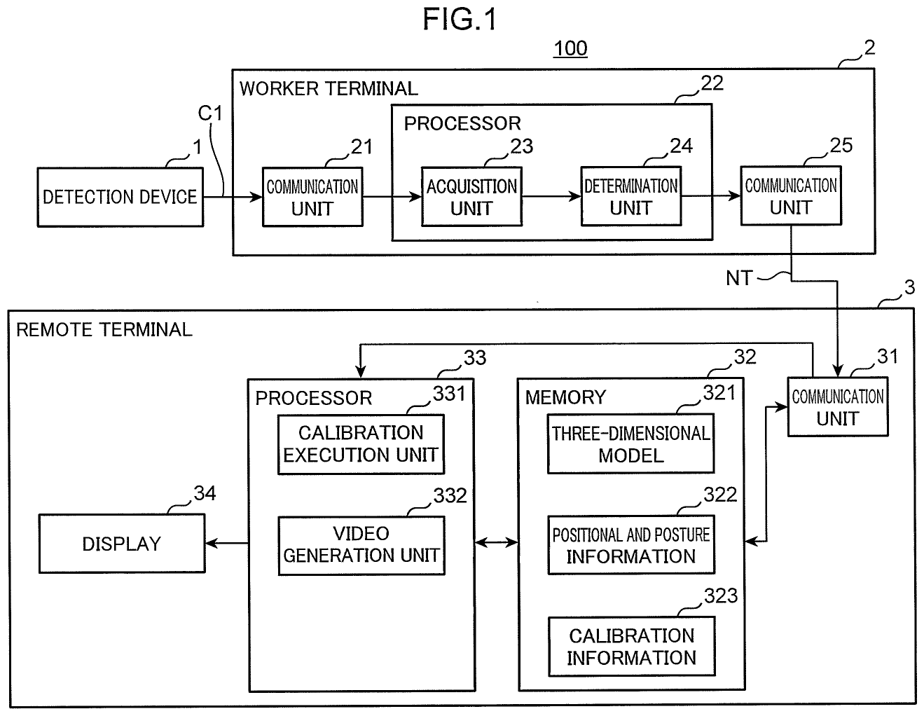

FIG. 1 is a block diagram showing one example of an entire configuration of an information processing system 100 according to a first embodiment. The information processing system 100 is a system in which a remote person at a remote place supports a worker who works on a target object. Specifically, this is a system that reproduces an image visually recognized by the worker who is at a worksite in a virtual space, and allows the remote person to visually recognize a video of the virtual space, thereby supporting the work of the worker from the remote place while sharing information between the worker and the remote person. The virtual space is a virtual three-dimensional space constructed inside a computer.

The information processing system 100 includes a detection device 1, a worker terminal 2, and a remote terminal 3. The detection device 1 and the worker terminal 2 are located at the worksite where the target object is installed. The remote terminal 3 is located at the remote place. The detection device 1 and the worker terminal 2 are communicably connected via a communication channel C1. The communication channel C1 may be, for example, a wireless communication channel such as a wireless LAN or Bluetooth (registered trademark), or may be a wired communication channel. The worker terminal 2 and the remote terminal 3 are connected via a network NT. The network NT is a wide-area communication network including the Internet, for example.

The detection device 1 is a sensor that detects the position and posture of the worker at the worksite. One example of the detection device I can adopt an optical motion capture system and a self-location estimation system. The optical motion capture system is a system that detects the position and posture of the worker by capturing the worker wearing a marker on the head with an optical tracker. The self-location estimation system is a system that detects the position and posture of the worker by capturing an image of the worksite with a camera worn by the worker, and applying the simultaneous localization and mapping (SLAM) technology to the image obtained. Note that in the self-location estimation system, a laser sensor such as Lidar may be used instead of the camera to detect the position and posture of the worker.

The detection device 1 transmits, to the worker terminal 2, positional information indicating the detected position of the worker and posture information indicating the posture of the worker. As the positional information, three-dimensional coordinate data indicating the position of a specific part of the worker (for example, the head) in the real space can be adopted. As the posture information, a three-dimensional vector indicating the direction of the worker's head in the real space can be adopted. As the direction of the head, for example, the front direction of the head can be adopted.

The detection device 1 detects the position and posture of the worker at a predetermined sampling rate and transmits the positional information and the posture information at a predetermined sampling rate to the worker terminal 2. This allows the remote terminal 3 to acquire the positional information and the posture information in real time.

The worker terminal 2 is, for example, a portable information terminal carried by the worker. Examples of the portable information terminal include a smartphone, a tablet computer, and a smart glass. The worker terminal 2 includes a communication unit 21, a processor 22, and a communication unit 25. The communication unit 21 includes a communication circuit capable of communicating with the detection device 1. The communication unit 21 receives the positional information and the posture information transmitted from the detection device 1 at a predetermined sampling rate.

The processor 22 is configured using a central processing unit (CPU), and includes an acquisition unit 23 and a determination unit 24. The acquisition unit 23 and the determination unit 24 are implemented by the processor 22 executing an information processing program.

Note that the acquisition unit 23 and the determination unit 24 may be implemented with a dedicated hardware circuit such as an ASIC.

The acquisition unit 23 acquires the positional information and the posture information transmitted from the detection device 1 at a predetermined sampling rate via the communication unit 21.

The determination unit 24 determines whether the worker is in a stable state based on the positional information acquired by the acquisition unit 23. The stable state refers to a state in which the worker is not accelerating and decelerating, that is, the state in which the worker is stopped and the state in which the worker is moving at a constant speed.

The determination unit 24 calculates the worker's acceleration level by taking the second derivative of the positional information. When the absolute value of the calculated acceleration level exceeds a reference acceleration level, the determination unit 24 determines that the worker is not in the stable state, that is, the worker is in an acceleration or deceleration state in which the worker is accelerating or decelerating. On the other hand, when the absolute value of the calculated acceleration level is less than the reference acceleration level, the determination unit 24 determines that the worker is in the stable state, that is, the worker is not in the acceleration or low-speed state. The acceleration state refers to a state from when the worker starts an accelerating action to move until the worker reaches a certain moving speed. The deceleration state refers to a state from when the moving worker starts a decelerating action to stop until the worker stops.

Upon determination that the worker is in the acceleration or deceleration state, the determination unit 24 does not transfer the positional information and the posture information acquired by the acquisition unit 23 to the remote terminal 3 by using the communication unit 25. On the other hand, upon determination that the worker is not in the acceleration or deceleration state, the determination unit 24 transfers the positional information and the posture information acquired by the acquisition unit 23 to the remote terminal 3 by using the communication unit 25.

The communication unit 25 includes a communication circuit that connects the worker terminal 2 to the network NT. The communication unit 25, under the control of the determination unit 24, transmits the positional information and the posture information to the remote terminal 3.

The remote terminal 3 is, for example, a terminal installed at a remote place away from the worksite. The remote terminal 3 may include a desktop computer or a portable computer such as a smartphone or a tablet computer.

The remote terminal 3 includes a communication unit 31, a memory 32, a processor 33, and a display 34. The communication unit 31 includes a communication circuit that connects the remote terminal 3 to the network NT, and acquires the positional information and the posture information transmitted from the worker terminal 2.

The memory 32 includes a rewritable non-volatile storage device such as a solid state drive and a hard disk drive, and stores a three-dimensional model, the positional information, the posture information, and calibration information. The three-dimensional model is a three-dimensional model that imitates the shape of the target object.

The positional information and the posture information are positional information and posture information transmitted from the worker terminal 2. The calibration information is information that associates the virtual space with the real space that indicates the worksite. The calibration information includes a real reference vector and a virtual reference vector. The real reference vector is a three-dimensional vector whose starting point is the worker's initial position in the real space and whose ending point is the position of the target object. The virtual reference vector is a three-dimensional vector whose starting point is the worker's initial position in the virtual space and whose ending point is the position of the three-dimensional model of the target object. The calibration information is generated by executing spatial calibration to be described later.

The processor 33 is configured using, for example, a central processing unit (CPU), and includes a calibration execution unit 331 and a video generation unit 332. The calibration execution unit 331 and the video generation unit 332 are implemented by the processor 33 executing the information processing program. However, this is one example, and the calibration execution unit 331 and the video generation unit 332 may be configured using a dedicated hardware circuit such as an ASIC. The calibration execution unit 331 executes the spatial calibration that associates the virtual space with the real space indicating the worksite. The spatial calibration is executed as pre-processing before the worker starts the work at the worksite.

The video generation unit 332 updates the position and posture of the worker by using the position and posture of a virtual camera installed in the virtual space based on the positional information and the posture information. This allows the position and posture of the worker to be synchronized with the position and posture of the virtual camera. The video generation unit 332 generates a virtual camera video obtained by capturing the virtual space with the synchronized virtual camera. The video generation unit 323 displays the virtual camera video on the display 34.

The display 34 is configured using a display device such as a liquid crystal display panel, and displays the virtual camera video generated by the video generation unit 323.

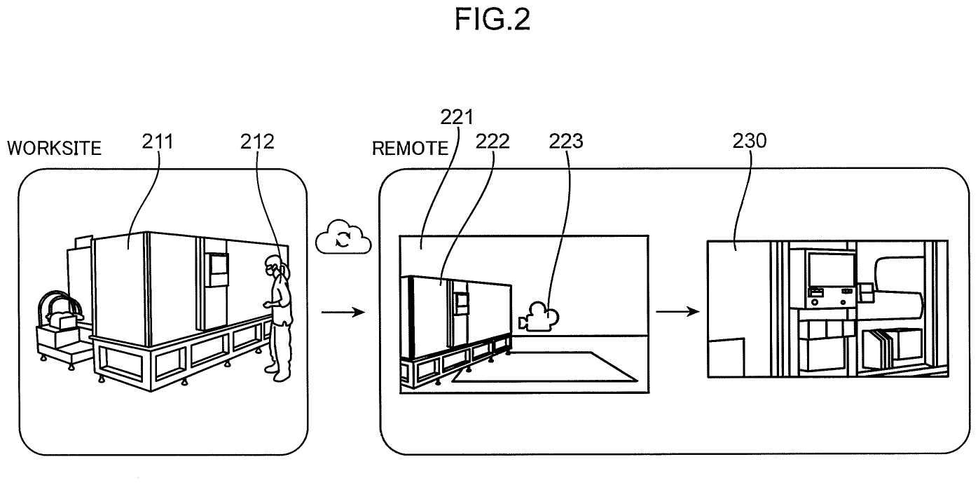

FIG. 2 is a diagram showing an outline of the process of the information processing system 100. A target object 211 is installed at the worksite. A worker 212 performs some work on the target object 211 at the worksite. The information processing system 100 reproduces the image within the field of view of the worker 212 in the virtual space. Specifically, the information processing system 100 constructs a three-dimensional model 222 that imitates the target object 211 in a virtual space 221, and captures the three-dimensional model 222 with a virtual camera 223 disposed in the virtual space 221. As a result, a virtual camera video 230 is generated. The generated virtual camera video 230 is displayed on the display 34 of the remote terminal 3 at the remote place. Here, the virtual camera 223 is synchronized with the position and posture of the worker 212. As a result, the remote person who visually recognizes the virtual camera video can confirm which position of the target object 211 the worker 212 is watching closely. As a result, the remote person can appropriately support the worker.

The worksite is, for example, the real space where the target object is installed. Examples of the worksite include a factory, an experiment site, a test site, and a chemical plant. The factory may be a factory that manufactures electrical products such as televisions and washing machines, or may be a factory that manufactures automobiles, iron, and the like. These worksites are one example, and may be any place as long as the worker performs a work on the target object. For example, the worksite may be a place where maintenance of equipment or facility is performed.

Examples of the target object include a facility to be maintained and a product manufactured on a manufacturing line. Examples of the product include an electrical appliance and an automobile. Examples of the facility include a manufacturing line of a factory.

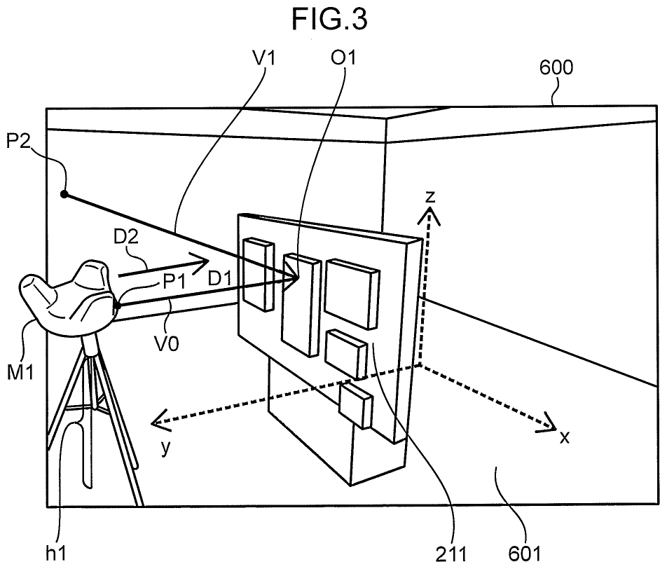

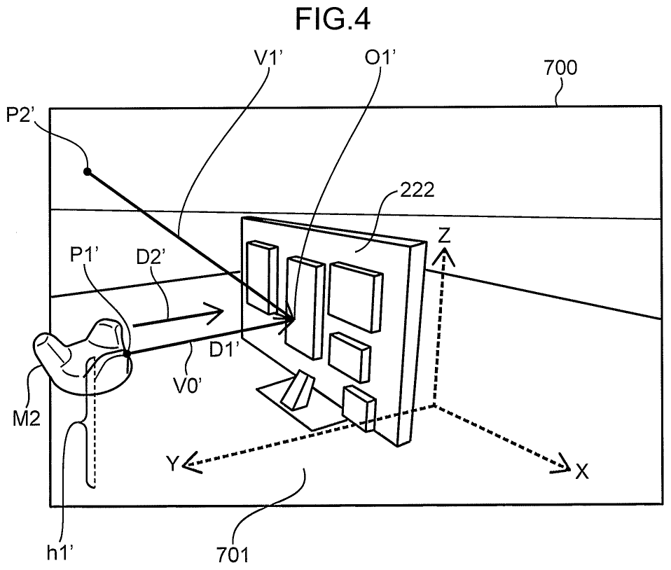

Next, one example of the spatial calibration will be described. FIGS. 3 and 4 are diagrams showing a state of the spatial calibration. A real space 600 is a three-dimensional real space depicting the worksite and is defined by mutually orthogonal x, y, and z axes. A virtual space 700 is a three-dimensional virtual space imitating the worksite and is defined by mutually orthogonal X, Y and Z axes.

The calibration execution unit 331 acquires an initial position P1 of a marker M1 that is installed at a position a reference distance D1 away from the target object 211 in the real space 600. Here, it is assumed that a height h1 of the initial position P1 from a ground surface 601 is the same as the height of a center position O1 of the target object 211 from the ground surface 601, and that a posture direction D2 of the marker M1 is parallel to the ground surface 601. The initial position P1 is detected by the detection device 1 and is transmitted to the remote terminal 3 via the worker terminal 2.

Next, the calibration execution unit 331 installs a virtual marker M2 and the three-dimensional model 222 in the virtual space 700 such that the relative positional relationship of the initial position P1 and the center position O1 in the real space 600 is maintained. In more detail, the calibration execution unit 331 installs the virtual marker M2 at a height h1′ corresponding to the height h1 from a virtual ground surface 701 such that a posture direction D2′ is parallel to the virtual ground surface 701 in the virtual space 700. Next, the calibration execution unit 331 installs the three-dimensional model 222 at a center position O1′ a reference distance D1′ away from the virtual marker M2 in parallel to the posture direction D2′. Next, the calibration execution unit 331 calculates a real reference vector V0 from the initial position P1 to the center position O1 and a virtual reference vector V0′ from a virtual initial position P1′ to the center position O1′. Next, the calibration execution unit 331 stores the real reference vector V0 and the virtual reference vector V0′ in the memory 32 as the calibration information. Here, the spatial calibration using the marker M1 is shown as an example, but the spatial calibration may be executed using the head position of the worker as the initial position P1 instead of the marker M1.

Next, one example of the synchronization process will be described. With reference to FIG. 3, it is assumed that during work, the marker M1 worn on the head of the worker is located at a position P2. In this case, the video generation unit 332 calculates the vector from the position P2 to the center position O1 as a real space vector V1. The real space vector V1 is a vector indicating the relative position of the worker during work with respect to the target object 211. Next, the video generation unit 332 calculates a difference vector ΔV between the real space vector V1 and the real reference vector V0.

Next, with reference to FIG. 4, the video generation unit 332 adds the difference vector ΔV to the virtual reference vector V0′ in the virtual space 700 to calculate a virtual space vector V1′. The virtual space vector V1′ is a vector indicating the relative position of the worker during work with respect to the three-dimensional model 222. Next, the video generation unit 332 determines a start point of the virtual space vector V1′ (position P2′) as the position of the virtual camera. Next, the video generation unit 332 determines the posture of the worker detected by the detection device 1 as the posture of the virtual camera. Here, the worker wears the marker M1 on the head, but the present disclosure is not limited to this example, and the worker does not have to wear the marker M1 on the head. In this case, the video generation unit 332 may calculate the position P2′ by using the position of the head of the worker detected by the detection device 1 as the position P2.

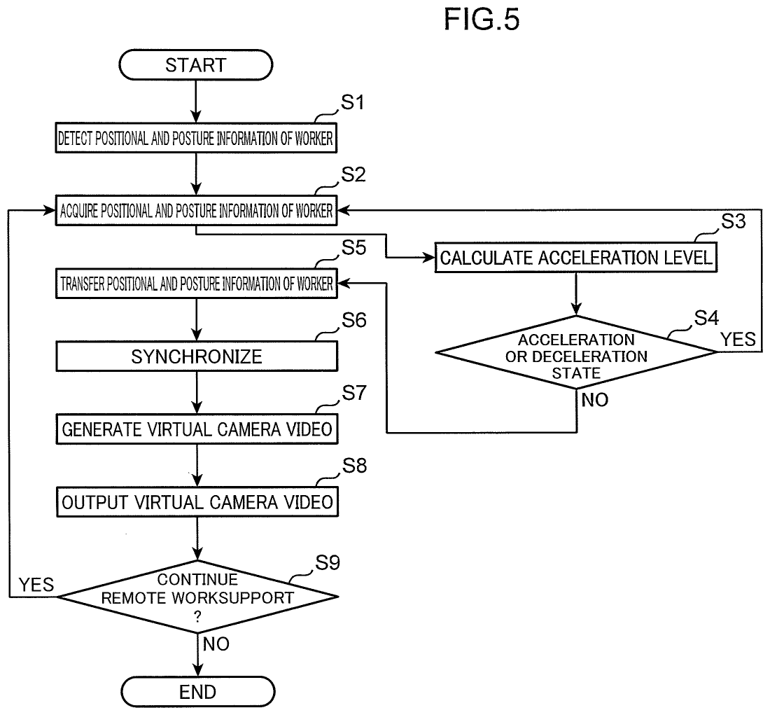

FIG. 5 is a flowchart showing one example of the process of the information processing system 100 in the first embodiment. The process is started when the worker starts work at the worksite. It is assumed that the spatial calibration has been executed before this process is started.

In step S1, the detection device 1 detects the positional information and the posture information of the worker. Next, in step S2, the acquisition unit 23 of the worker terminal 2 acquires the positional information and the posture information by using the communication unit 21. Next, in step S3, the determination unit 24 of the worker terminal 2 calculates the acceleration level by taking the second derivative of the positional information acquired in step S2.

Next, in step S4, the determination unit 24 determines whether the worker is in the acceleration or deceleration state by using the acceleration level calculated in step S3.

In more detail, the determination unit 24 determines that the worker is in the acceleration or deceleration state when the absolute value of the acceleration level exceeds the reference acceleration level, and determines that the worker is not in the acceleration or deceleration state when the absolute value of the acceleration level is less than the reference acceleration level. When it is determined that the worker is in the acceleration or deceleration state (YES in step S4), the process returns to step S2. In this case, the positional information and the posture information are not transmitted to the remote terminal 3. Therefore, the position and posture of the virtual camera are not updated by using the positional information and the posture information. On the other hand, when it is determined that the worker is not in the acceleration or deceleration state (NO in step S4), the process proceeds to step S5.

Next, in step S5, the determination unit 24 uses the communication unit 25 to transfer the positional information and the posture information acquired in step S2 to the remote terminal 3.

Next, in step S6, the video generation unit 332 of the remote terminal 3 synchronizes the position and posture of the worker with the position and posture of the virtual camera by using the positional information and the posture information transferred in step S5 and the calibration information. Details of the synchronization process have been described above.

Next, in step S7, the video generation unit 332 generates the virtual camera video captured by the synchronized virtual camera. In this case, the video generation unit 332 generates the virtual camera video by rendering the virtual space with the virtual camera.

Next, in step S8, the video generation unit 332 displays the virtual camera video on the display 34.

Next, in step S9, the video generation unit 332 determines whether the remote work support will be continued. When the remote work support will be continued (YES in step S9), the process returns to step S2. When the remote work support will not be continued (NO in step S9), the process ends. The termination of the remote work support is executed by the worker inputting an instruction to terminate the remote work support to the worker terminal 2. Therefore, the video generation unit 332 may determine that the remote work support is terminated when the communication unit 31 receives this instruction from the worker terminal 2, and determine that the remote work support will be continued when this instruction is not received.

In this way, according to the first embodiment, only when the worker is in the stable state, the positional information and the posture information are output, preventing the position and posture of the virtual camera from being updated by using the position and posture of the worker during a period of significant movement. Therefore, the position and posture of the virtual camera become stable, preventing the virtual camera video with rapid changes and low visibility from being generated.

### Second Embodiment

The second embodiment determines that the worker is not in a stable state when the worker's speed exceeds a reference speed. In the present embodiment, the same constituent as in the first embodiment is denoted with the same reference sign, and descriptions thereof will be omitted. In the present embodiment, the block diagram of FIG. 1 is used.

In FIG. 1, a determination unit 24 calculates the speed of the worker by taking the first derivative of positional information acquired by an acquisition unit 23. When the calculated speed exceeds the reference speed, the determination unit 24 determines that the worker is not in the stable state, that is, the worker is moving. On the other hand, when the calculated speed is less than the reference speed, the determination unit 24 determines that the worker is in the stable state, that is, the worker is not moving.

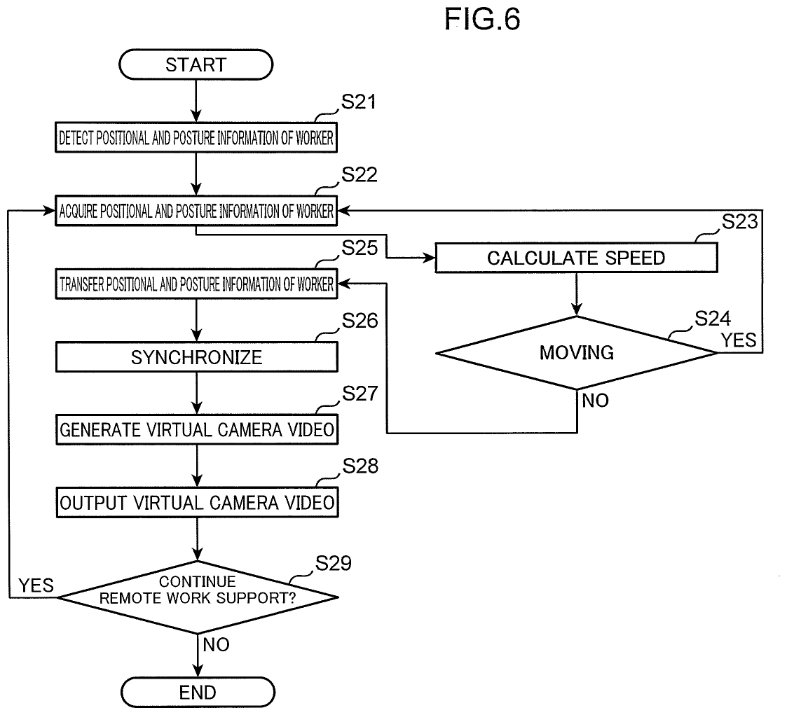

FIG. 6 is a flowchart showing one example of the process of an information processing system 100 in the second embodiment. Steps S21, S22, and S25 to S29 are the same as steps S1, S2, and S5 to S9 in FIG. 5, and thus description thereof will be omitted.

In step S23 following step S22, the determination unit 24 calculates the speed by taking the first derivative of the positional information acquired by the acquisition unit 23.

Next, in step S24, the determination unit 24 compares the speed calculated in step S23 with the reference speed to determine whether the worker is moving. In more detail, when the speed exceeds the reference speed, the determination unit 24 determines that the worker is moving (YES in step S24), and the process returns to step S22. In this case, the positional information and the posture information are not transferred to a remote terminal 3. Therefore, the position and posture of the virtual camera are not updated by using the positional information and the posture information. On the other hand, when the speed is less than the reference speed, the determination unit 24 determines that the worker is not moving (NO in step S24), and the process proceeds to step S25. In this case, the positional information and the posture information are transferred to the remote terminal 3.

In this way, according to the second embodiment, it is prevented that the position and posture of the virtual camera are updated by using the position and posture of the moving worker, making it possible to prevent a virtual camera video with rapid changes and low visibility from being generated.

### Third Embodiment

The third embodiment controls an update of positional information and posture information by taking into account the period from the last update of the positional information and the posture information in the first embodiment. In the present embodiment, the same constituent as in the first and second embodiments is denoted with the same reference sign, and descriptions thereof will be omitted. In the present embodiment, the block diagram of FIG. 1 is used.

In FIG. 1, on determination that the worker is in an acceleration or deceleration state, a determination unit 24 determines whether the period from the last update of the positional information and the posture information to the present time exceeds a certain period. When such a period exceeds the certain period, the determination unit 24 transfers the positional information and the posture information to a remote terminal 3 by using a communication unit 25. When such a period does not exceed the certain period, the determination unit 24 does not transfer the positional information and the posture information. As the certain period, an appropriate value such as one minute, three minutes, or the like is adopted.

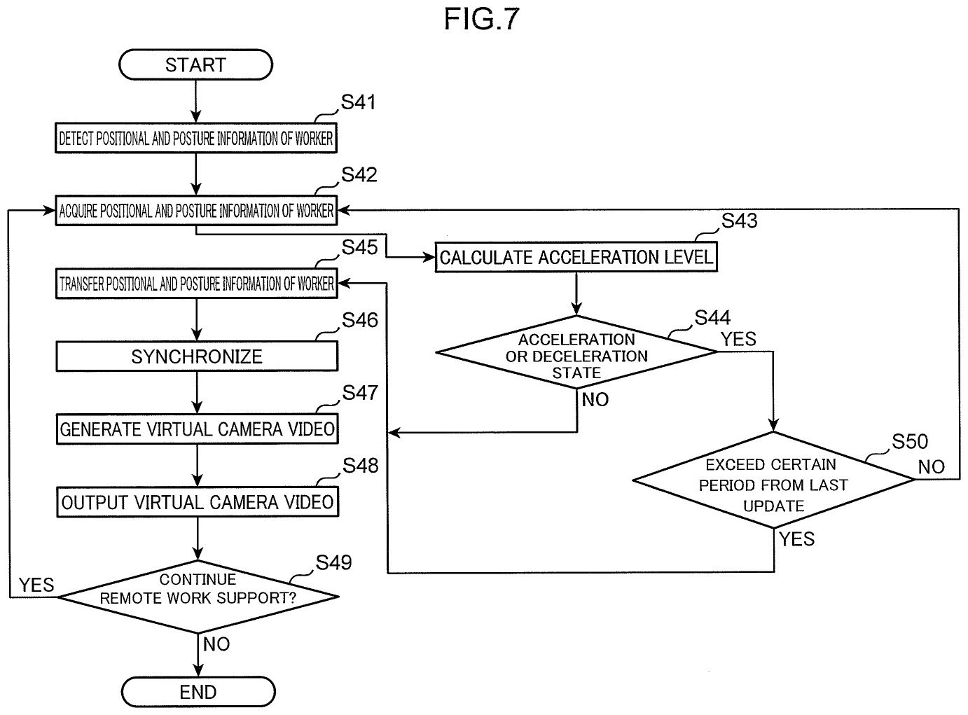

FIG. 7 is a flowchart showing one example of the process of an information processing system 100 in the third embodiment. Steps S41 to S43 and S45 to S49 are the same as steps S1 to S3 and S5 to S9 in FIG. 5, and thus description thereof will be omitted.

In step S44, when it is determined that the worker is in the acceleration or deceleration state (YES in step S44), the determination unit 24 determines whether the period from the last update of the positional information and the posture information to the present time exceeds the certain period (step S50). When such a period exceeds the certain period (YES in step S50), the process proceeds to step S45. In this case, the positional information and the posture information are transferred to the remote terminal 3. Therefore, the position and posture of a virtual camera are updated by using the positional information and the posture information. On the other hand, when such a period does not exceed the certain period (NO in step S50), the process return to step S42. In this case, the positional information and the posture information are not transferred to the remote terminal 3. Therefore, the position and posture of the virtual camera are not updated by using the positional information and the posture information.

In this way, according to the third embodiment, even when it is determined that the worker is not in the acceleration or deceleration state, when the period from the last update of the positional information and the posture information to the present time exceeds the certain period, the positional information and the posture information are transferred to the remote terminal 3, and the position and posture of the virtual camera are updated using the transferred positional information and the posture information. This makes it possible to prevent the position and posture of the worker from becoming out of sync with the position and posture of the virtual camera for a long period of time. This allows the remote person to appropriately manage the worker.

### Fourth Embodiment

The fourth embodiment controls an update of positional information and posture information by taking into account the period from the last update of the positional information and the posture information in the second embodiment. In the present embodiment, the same constituent as in the first to third embodiments is denoted with the same reference sign, and descriptions thereof will be omitted. In the present embodiment, the block diagram of FIG. 1 is used.

In FIG. 1, upon determination that the worker is moving, a determination unit 24 determines whether the period from the last update of the positional information and the posture information to the present time exceeds a certain period. When such a period exceeds the certain period, the determination unit 24 transfers the positional information and the posture information to a remote terminal 3 by using a communication unit 25. When such a period does not exceed the certain period, the determination unit 24 does not transfer the positional information and the posture information. As the certain period, an appropriate value such as one minute, three minutes, ten minutes, or the like is adopted.

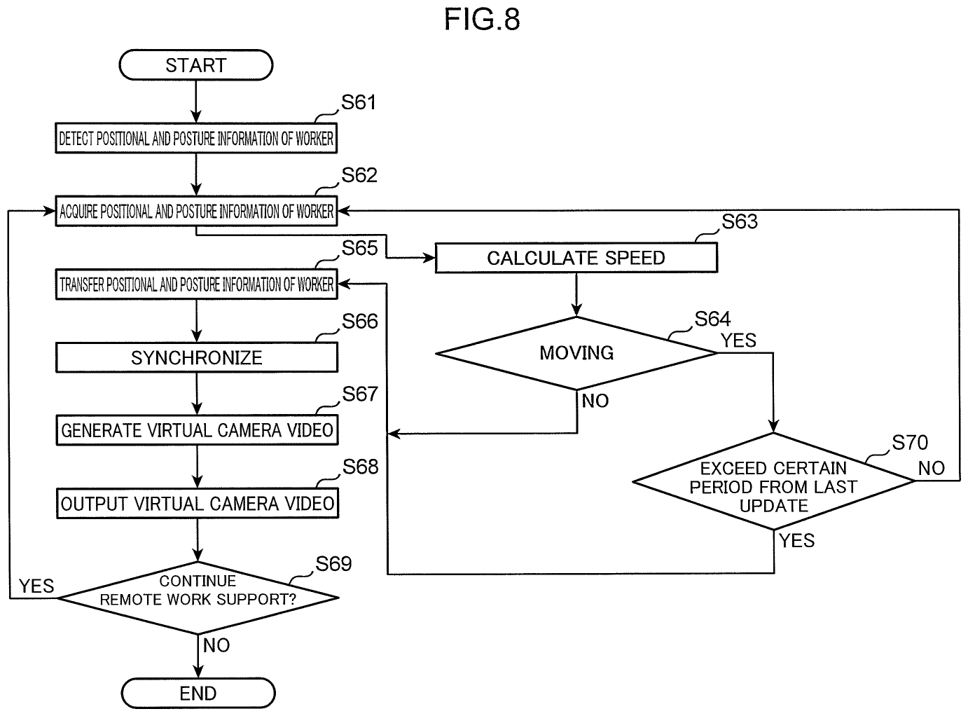

FIG. 8 is a flowchart showing one example of the process of an information processing system 100 in the fourth embodiment. Steps S61 to S63 and S65 to S69 are the same as steps S21 to S23 and S25 to S29 in FIG. 6, and thus description thereof will be omitted.

In step S64, when it is determined that the worker is moving (YES in step S64), the determination unit 24 determines whether the period from the last update of the positional information and the posture information to the present time exceeds the certain period (step S70). When such a period exceeds the certain period (YES in step S70), the process proceeds to step S65. In this case, the positional information and the posture information are transferred to the remote terminal 3. Therefore, the position and posture of a virtual camera are updated by using the positional information and the posture information. On the other hand, when such a period does not exceed the certain period (NO in step S70), the process returns to step S62. In this case, the positional information and the posture information are not transferred to the remote terminal 3. Therefore, the position and posture of the virtual camera are not updated by using the positional information and the posture information.

In this way, according to the fourth embodiment, even when it is determined that the worker is not moving, when the period from the last update of the positional information and the posture information to the present time exceeds the certain period, the positional information and the posture information are transferred to the remote terminal 3, and the position and posture of the virtual camera are updated using the transferred positional information and the posture information. This makes it possible to prevent the position and posture of the virtual camera from being not updated by using the position and posture of the worker for a long period of time, allowing the remote person to manage the worker appropriately.

### Fifth Embodiment

The fifth embodiment performs a correction process on positional information and posture information in the first embodiment. In the present embodiment, the same constituent as in the first to fourth embodiments is denoted with the same reference sign, and descriptions thereof will be omitted. In the present embodiment, the block diagram of FIG. 1 is used.

In FIG. 1, an acquisition unit 23 performs the correction process to correct the positional information and the posture information by applying a low-pass filter to displacement of the positional information and displacement of the posture information of a worker. The displacement of the positional information is, for example, a difference between the positional information at the current sample time and the positional information at the immediately preceding sample time, that is, the movement speed. Since the positional information includes three-dimensional coordinate data, the difference in the positional information is represented as a difference in the three-dimensional coordinate data. The displacement of the posture information is a difference between the posture information at the current sample time and the posture information at the immediately preceding sample time, that is, the speed in which the posture changes. Since the posture information is represented as a three-dimensional vector, the difference in the posture information is represented as a three-dimensional vector.

The correction process includes, in a determination unit 24, making a cutoff frequency of the low-pass filter lower when it is determined that the worker is not in an acceleration or deceleration state, rather than when it is determined that the worker is in the acceleration or deceleration state.

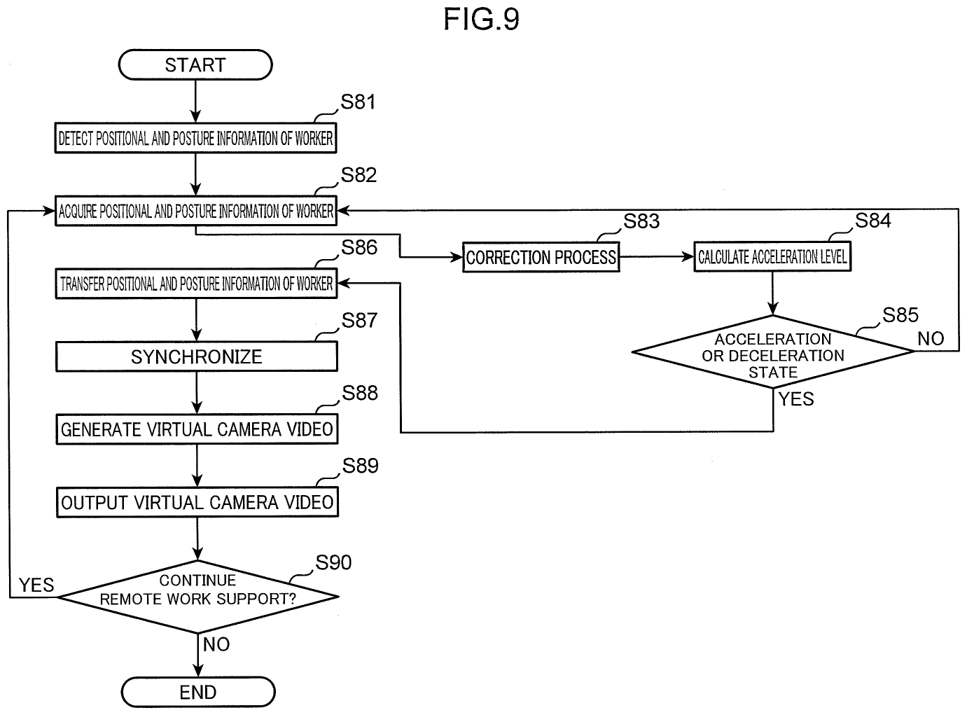

FIG. 9 is a flowchart showing one example of the process of an information processing system 100 in the fifth embodiment. Steps S81 to S82 and S84 to S90 are the same as steps S1 to S2 and S3 to S9 in FIG. 5, and thus description thereof will be omitted. That is, the difference is that the correction process has been added in step S83.

In step S83, the acquisition unit 23 performs the correction process to correct the positional information and the posture information by applying the low-pass filter to displacement of the positional information and displacement of the posture information on a worker. It is assumed that, for example, the bands of the displacement of the positional information and the displacement of the posture information are divided in advance into low-frequency, mid-frequency, and high-frequency regions. In this case, when it is determined that the worker is in the acceleration or deceleration state, the acquisition unit 23 may set the cutoff frequency and the cutoff frequency of the low-pass filter to a first frequency on the boundary between the low-frequency region and the mid-frequency region. On the other hand, when it is determined that the worker is not in the acceleration or deceleration state, the acquisition unit 23 may set the cutoff frequency of the low-pass filter to a second frequency (>first frequency) on the boundary between the mid-frequency region and the high-frequency region. As a result, when the worker is in the acceleration or deceleration state, the high-frequency and mid-frequency regions are cut off, and when the worker is not in the acceleration or deceleration state, the high-frequency region is cut off.

Details of the correction process are as follows. The value of the positional information or the posture information at a sample time t is set to z(t). The displacement of the value between the sample time (t-1) and the sample time t is set to Δz(t). The acquisition unit 23 applies the low-pass filter in which the first frequency or the second frequency is set to the displacement Δz(t). The displacement after application of the low-pass filter is set to Δz′(t). The acquisition unit 23 calculates the corrected value z′(t) at the sample time t by adding Δz′(t) to the value z(t-1) at the sample time (t-1). The acquisition unit 23 performs the correction process by applying such a process to each sample time.

In this way, according to the fifth embodiment, when the worker is in the acceleration or deceleration state, the cutoff frequency of the low-pass filter is shifted to the lower frequency side, rather than when the worker is not in the acceleration or deceleration state. Therefore, the positional information and the posture information are acquired with rapid changes removed. This prevents the virtual camera video with rapid changes and low visibility from being generated. In addition, since the positional information becomes stable, the accuracy of determining whether the worker is in a stable state improves.

Modifications described below can be adopted for the present disclosure.
(1) In the first to fifth embodiments, the position and posture of the virtual camera are updated using the positional information and the posture information only when the worker is in the stable state. However, the present disclosure is not limited this example, and when the worker is not in the stable state, the frequency of such update may be reduced, rather than when the worker is in the stable state. For example, the determination unit 24 may transfer the positional information and the posture information to the remote terminal 3 at a first sampling rate when the worker is in the stable state, and may transfer the positional information and the posture information to the remote terminal 3 at a second sampling rate when the worker is not in the stable state. Here, for the second sampling rate, a value lower than the first sampling rate can be adopted. For the first sampling rate, the sampling rate at which the detection device 1 detects the positional information and the posture information can be adopted.
(2) The correction process shown in the fifth embodiment may be applied to the second to fourth embodiments. In particular, when the correction process is applied to the third and fourth embodiments, if it is determined YES in step S50 or YES in step S70, the synchronization process is performed using the positional information and the posture information with rapid movement reduced, thereby suppressing generation of the virtual camera video with rapid changes.
(3) In the first to fifth embodiments, the positional information is calculated using the optical motion capture system or SLAM technology, but values detected by a GPS sensor may also be adopted.
(4) In FIG. 1, the acquisition unit 23 and the determination unit 24 are provided in the worker terminal 2, but may be provided in the processor 33 in the detection device 1 or the remote terminal 3.
(5) The information processing device may include the worker terminal 2, or may include the worker terminal 2 and the remote terminal 3. The display 34 may be removed from components of the remote terminal 3.

The present disclosure is useful in the technical field of remotely supporting the worker at the worksite.

1. An information processing method in an information processing device for supporting work of a worker, the information processing method comprising:
acquiring positional information and posture information of the worker in a real space, the positional information and the posture information being used to update a position and posture of a virtual camera installed in a virtual space imitating the real space;
determining whether the worker is in a stable state based on the positional information; and
reducing an updating frequency of the positional information and the posture information when it is determined that the worker is not in the stable state, rather than when it is determined that the worker is in the stable state.

2. The information processing method according to claim 1, wherein the stable state indicates a state where the worker is not accelerating or decelerating.

3. The information processing method according to claim 2, wherein the determination includes: calculating an acceleration level from the positional information: determining that the worker is not in the stable state when an absolute value of the acceleration level exceeds a reference acceleration level; and determining that the worker is in the stable state when the absolute value of the acceleration level is less than the reference acceleration level.

4. The information processing method according to claim 1, wherein the stable state indicates a state where the worker is stopped.

5. The information processing method according to claim 4, wherein the determination includes: calculating a speed from the positional information; determining that the worker is not in the stable state when the speed exceeds a reference speed; and determining that the worker is in the stable state when the speed is less than the reference speed.

6. The information processing method according to claim 1, wherein
the determination includes determining whether a period from a last update of the positional information and the posture information until present time exceeds a certain period when it is determined that the worker is not in the stable state, and
the reducing the updating frequency includes performing the update when it is determined that the period exceeds the certain period.

7. The information processing method according to claim 1, further comprising
performing a correction process to correct the positional information and the posture information by applying a low-pass filter to displacement of the positional information and displacement of the posture information,
wherein the correction process includes making a cutoff frequency of the low-pass filter lower when it is determined that the worker is not in the stable state, rather than when it is determined that the worker is in the stable state.

8. The information processing method according to claim 1, further comprising:
updating the position and posture of the virtual camera by using the positional information and the posture information;
generating a virtual camera video by capturing the virtual space with the virtual camera; and
displaying the virtual camera video on a display.

9. The information processing method according to claim 1, wherein
the reducing the updating frequency includes:
not performing the update when it is determined that the worker is not in the stable state; and
performing the update when it is determined that the worker is in the stable state.

10. An information processing device including a processor and supporting work of a worker, wherein
the processor performs processing of:
acquiring positional information and posture information of the worker in a real space, the positional information and the posture information being used to update a position and posture of a virtual camera installed in a virtual space imitating the real space;
determining whether the worker is in a stable state based on the positional information; and
reducing an updating frequency of the positional information and the posture information when it is determined that the worker is not in the stable state, rather than when it is determined that the worker is in the stable state.

11. A non-transitory computer readable recording medium storing an information processing program for causing a computer to execute an information processing method for supporting work of a worker, the information processing program causing the computer to perform processing of:
acquiring positional information and posture information of the worker in a real space, the positional information and the posture information being used to update a position and posture of a virtual camera installed in a virtual space imitating the real space;
determining whether the worker is in a stable state based on the positional information; and
reducing an updating frequency of the positional information and the posture information when it is determined that the worker is not in the stable state, rather than when it is determined that the worker is in the stable state.
